(19) United States
(12) Patent Application Publication
(10) Pub. No.: US 2023/0086684 A1
(43) Pub. Date: Mar. 23, 2023

(54) TONER FOR DEVELOPING ELECTROSTATIC CHARGE IMAGE, ELECTROSTATIC CHARGE IMAGE DEVELOPER, TONER CARTRIDGE, PROCESS CARTRIDGE, AND IMAGE FORMING APPARATUS

(71) Applicant: FUJIFILM Business Innovation Corp., Tokyo (JP)

(72) Inventors: Daisuke ISHIZUKA, Kanagawa (JP); Eiji KAWAKAMI, Kanagawa (JP); Shinya SAKAMOTO, Kanagawa (JP); Keita YAMAMOTO, Kanagawa (JP)

(73) Assignee: FUJIFILM Business Innovation Corp., Tokyo (JP)

(21) Appl. No.: 17/705,809

(22) Filed: Mar. 28, 2022

(30) Foreign Application Priority Data
Sep. 21, 2021 (JP) 2021-153564

(51) Int. Cl. G03G 9/087; G03G 9/08; C08G 63/183; G03G 15/08

(52) U.S. Cl. CPC G03G 9/08755; G03G 9/0825; C08G 63/183; G03G 15/0865

(57) ABSTRACT

A toner for developing an electrostatic charge image incorporates toner particles that contain binder resins, in which: the binder resins include amorphous resins and at least one crystalline resin, the amorphous resins including amorphous resin a1 and amorphous resin a2, the crystalline resin including crystalline resin cl; and

10,000≤Mw(a2)−Mw(a1)≤150,000 (1), and

|SP(a1)−SP(c1)|/|SP(a2)−SP(c1)|≤0.9 (2),

where Mw (al) is the weight-average molecular weight of amorphous resin a1, Mw (a2) is that of amorphous resin a2, SP (a1) is the solubility parameter (SP) of amorphous resin a1, SP (a2) is that of amorphous resin a2, and SP (c1) is that of crystalline resin c1.

### CROSS-REFERENCE TO RELATED APPLICATIONS

This application is based on and claims priority under 35 USC 119 from Japanese Patent Application No. 2021-153564 filed Sep. 21, 2021.

### BACKGROUND

### (i) Technical Field

The present disclosure relates to a toner for developing an electrostatic charge image, an electrostatic charge image developer, a toner cartridge, a process cartridge, and an image forming apparatus.

### (ii) Related Art

Electrophotography and other techniques for visualizing image information are used in various fields today. In electrophotographic visualization of image information, the surface of an image carrier is charged, and an electrostatic charge image, which is the image information, is created thereon. Then a developer, which contains toner, is applied to form a toner image on the surface of the image carrier. This toner image is transferred to a recording medium and fixed on the recording medium.

For example, Japanese Unexamined Patent Application Publication No. 2018-141967 discloses “a toner binder comprising two or more amorphous polyester resins (P) each having a carboxylic acid component (x) and an alcohol component (y) as constituents and obtained by allowing the components to react together, wherein: at least one of the resins (P) is an amorphous polyester resin that contains, as a constituent, a C2 to C4 aliphatic diol (y1) in the alcohol component (y), with the diol (y1) constituting 50% to 100% by mole based on the number of moles of the alcohol component (y) (P1); at least one of the resins (P) is an amorphous polyester resin that contains, as a constituent, an alkylene oxide adduct of bisphenol A (y2) in the alcohol component (y), with the adduct (y2) constituting 51% to 100% by mole based on the number of moles of the alcohol component (y) (P2); the amorphous polyester resin (P1) has a weight-average molecular weight of 3000 to 30000; the amorphous polyester resin (P2) has a weight-average molecular weight of 10000 to 300000; the amorphous polyester resin (P2) is a nonlinear polyester; and 0.84<SPP2/SPP1<0.98 with regard to the solubility parameters, SPs, of the resins (P1) and (P2).”

Japanese Unexamined Patent Application Publication No. 2018-017786 discloses “a toner comprising toner particles containing a binder resin and a coloring agent, wherein: the binder resin contains a crystalline resin A and an amorphous resin B; when the toner is analyzed with a differential scanning calorimeter, an amount of heat at an endothermic peak for the crystalline resin A is 1.0 J/g or more and 20.0 J/g or less; |a−SPb|≤2.0, where SPa is an SP of the crystalline resin A, in (J/cm³)^{1/2}, and SPb is an SP of the amorphous resin B, in (J/cm³)^{1/2}; and when a cross-section of the toner is observed with a transmission electron microscope, TEM, the crystalline resin A forms a dendritic crystal.”

### SUMMARY

Some known toners for developing electrostatic charge images incorporate toner particles that contain amorphous and crystalline resins as binder resins, and using such a toner can cause band-shaped defects on the resulting image. Aspects of non-limiting embodiments of the present disclosure, therefore, relate to a toner, for developing an electrostatic charge image, that incorporates toner particles containing binder resins including amorphous and crystalline resins. This toner may help reduce the band-shaped defects compared with those that violate the condition represented by formula (2), given hereinbelow, or those for which when a Voronoi tessellation is generated from the centroids of islands in the sea-island structure of the toner particles, the coefficient of variation of the areas of the Voronoi cells is less than 0.3.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a toner for developing an electrostatic charge image, the toner incorporating toner particles that contain binder resins, wherein the binder resins include amorphous resins and at least one crystalline resin, the amorphous resins including amorphous resin a1 and amorphous resin a2, the crystalline resin including crystalline resin c1; and

10,000≤Mw(a2)−Mw(a1)≤150,000 (1), and

|SP(a1)−SP(c1)|/|SP(a2)−SP(c1)|≤0.9 (2),

where Mw (a1) is a weight-average molecular weight of amorphous resin a1, Mw (a2) is a weight-average molecular weight of amorphous resin a2, SP (a1) is a solubility parameter, SP, of amorphous resin a1, SP (a2) is a solubility parameter, SP, of amorphous resin a2, and SP (c1) is a solubility parameter, SP, of crystalline resin c1.

### BRIEF DESCRIPTION OF THE DRAWINGS

Exemplary embodiments of the present disclosure will be described in detail based on the following figures, wherein:

FIG. 1 is a schematic view of the structure of an example of an image forming apparatus according to an exemplary embodiment; and

FIG. 2 is a schematic view of the structure of an example of a process cartridge according to an exemplary embodiment attachable to and detachable from an image forming apparatus.

### DETAILED DESCRIPTION

The following describes exemplary embodiments of the present disclosure. The following description and Examples are merely examples of the disclosure and do not limit the scope of the disclosure.

Numerical ranges specified with “A-B,” “between A and B,” “(from) A to B,” etc., herein represent inclusive ranges, which include the minimum A and the maximum B as well as all values in between.

The following description also includes series of numerical ranges. In such a series, the upper or lower limit of a numerical range may be substituted with that of another in the same series. The upper or lower limit of a numerical range, furthermore, may be substituted with a value indicated in the Examples section.

A gerund or action noun used in relation to a certain process or method herein does not always represent an independent action. As long as its purpose is fulfilled, the action represented by the gerund or action noun may be continuous with or part of another.

A description of an exemplary embodiment herein may make reference to drawing(s). The reference, however, does not mean what is illustrated is the only possible configuration of the exemplary embodiment. The size of elements in each drawing is conceptual; the relative sizes of the elements do not need to be as illustrated.

An ingredient herein may be a combination of multiple substances. If a composition described herein contains a combination of multiple substances as one of its ingredients, the amount of the ingredient represents the total amount of the substances in the composition unless stated otherwise.

An ingredient herein, furthermore, may be a combination of multiple kinds of particles. If a composition described herein contains a combination of multiple kinds of particles as one of its ingredients, the diameter of particles of the ingredient is that of the mixture of the multiple kinds of particles present in the composition unless stated otherwise.

In the present disclosure, “toner for developing an electrostatic charge image” may be referred to simply as “toner.” “An electrostatic charge image developer,” likewise, may be referred to simply as “a developer.”

### Toner for Developing an Electrostatic Charge Image

Toner according to a first exemplary embodiment incorporates toner particles that contain binder resins. The binder resins include amorphous resins and at least one crystalline resin, the amorphous resins including amorphous resin a1 and amorphous resin a2, the crystalline resin including crystalline resin c1. In addition to this,

10,000≤Mw(a2)−Mw(a1)≤150,000 (1), and

|SP(a1)−SP(c1)|/|SP(a2)−SP(c1)|≤0.9 (2),

where Mw (a1) is the weight-average molecular weight of amorphous resin a1, Mw (a2) is the weight-average molecular weight of amorphous resin a2, SP (a1) is the solubility parameter (SP) of amorphous resin a1, SP (a2) is the solubility parameter (SP) of amorphous resin a2, and SP (c1) is the solubility parameter (SP) of crystalline resin c1.

Toner according to a second exemplary embodiment incorporates toner particles that contain binder resins. The toner particles have a sea-island structure in which the sea contains an amorphous resin, and the islands contain a crystalline resin. When a Voronoi tessellation is generated from the centroids of the islands in the sea-island structure, the coefficient of variation of the areas of the Voronoi cells is 0.3 or more.

Configured as described above, the toners according to the first and second exemplary embodiments may help reduce band-shaped defects on the resulting image. A possible reason is as follows.

Some known toner particles contain amorphous and crystalline resins as binder resins, and such toner particles form a sea-island structure in which the sea contains the amorphous resin, and the islands contain the crystalline resin. Inside the toner particles, the islands, containing a crystalline resin, tend to be highly dispersed. This means toner made with such toner particles is easily deformed by thermal or mechanical factors, for example at the fixing device, and sticks to the image carrier, developing element, and other components of the apparatus. Repeated image formation with such a toner can cause band-shaped defects on the resulting image.

The toner according to the first exemplary embodiment contains binder resins including amorphous resin a1, amorphous resin a2, and crystalline resin c1, varying in solubility parameter (SP) and weight-average molecular weight and meeting the conditions represented by formulae (1) and (2). The sea-island structure, therefore, tends to be formed with crystalline resin c1 in the islands and amorphous resins a1 and a2 in the sea. Because the solubility parameters (SPs) and weight-average molecular weights are as in formulae (1) and (2), amorphous resin a1, contained in the sea, has a relatively small weight-average molecular weight, and it is likely that part of amorphous resin a1 is highly compatible with crystalline resin c1, which is in the islands. The islands, containing crystalline resin c1, therefore tend to be localized, or concentrate in particular regions, inside the toner particles. By virtue of this, the toner is not easily deformed and stick to the image carrier, developing element, etc., even if exposed to thermal or mechanical factors, for example at the fixing device. The inventors believe this may help reduce the band-shaped defects.

As for the toner according to the second exemplary embodiment, the toner particles have a sea-island structure in which the sea contains an amorphous resin, and the islands contain a crystalline resin, and the coefficient of variation of the areas of Voronoi cells is 0.3 or more. The coefficient of variation of the areas of Voronoi cells is a measure of dispersion of the areas of the Voronoi cells, or in this context is a parameter used to determine variability in island occupation inside the toner particles. When coefficient of variation of the areas of Voronoi cells is 0.3 or more, the dispersion of the islands, containing a crystalline resin, inside the toner particles tends to be moderate; the islands tend to be localized, or concentrate in particular regions, inside the toner particles. By virtue of this, the toner is not easily deformed and stick to the image carrier, developing element, etc., even if exposed to thermal or mechanical factors, for example at the fixing device. The inventors believe this may help reduce the band-shaped defects.

The following describes a toner that is one according to the first exemplary embodiment while being one according to the second exemplary embodiment (hereinafter also referred to as “toner according to exemplary embodiments”) in detail. Any toner that is one according to at least one of the first or second exemplary embodiment, however, is an example of a toner according to an exemplary embodiment of the present disclosure.

The toner according to exemplary embodiments incorporates toner particles. The toner may incorporate external additives, i.e., additives present in the toner but outside the toner particles.

### Characteristics of the Toner Particles

### Sea-Island Structure

The toner particles according to the first exemplary embodiment may have, for further reduction of band-shaped defects on the resulting image, a sea-island structure in which the sea contains the amorphous resins whereas the islands contain the crystalline resin.

The toner particles according to the second exemplary embodiment have a sea-island structure in which the sea contains an amorphous resin, and the islands contain a crystalline resin.

For further reduction of band-shaped defects on the resulting image, the average diameter of the islands may be 100 nm or more and 800 nm or less. Preferably, this average diameter is 150 nm or more and 700 nm or less, more preferably 200 nm or more and 650 nm or less.

If the toner is produced by kneading and milling, the average diameter of the islands in the sea-island structure can be brought into these ranges by, for example, customizing the degree of kneading through the adjustment of the temperature and screw rotational speed for kneading or by tuning the rate of crystallization through the modification of the temperature to which the kneaded mixture is cooled. If the toner is produced by emulsion aggregation, the average diameter of the islands can be controlled by customizing the diameter of dispersed particles of the crystalline resin or the temperature at which the particles are fused together.

To check whether the toner particles have a sea-island structure and to measure the average diameter of the islands therein, the following method can be used.

A piece of epoxy resin with embedded toner therein is sliced, for example using a diamond knife, and the slice is stained with osmium tetroxide or ruthenium tetroxide in a desiccator. The stained slice is observed using a scanning electron microscope (SEM). If there is a sea-island structure, the osmium tetroxide or ruthenium tetroxide stains the resins to different shades in the sea and islands; this can be used to check whether the toner particles have a sea-island structure. In the SEM image, furthermore, 100 randomly chosen islands are measured along their major axis. The arithmetic mean of the 100 major axes is reported as the average diameter.

### Coefficient of Variation of the Areas of Voronoi Cells

For further reduction of band-shaped defects on the resulting image, the toner particles according to the first exemplary embodiment may be configured such that the coefficient of variation of the areas of Voronoi cells is 0.3 or more when a Voronoi tessellation is generated from the centroids of islands in a sea-island structure therein. Preferably, the coefficient of variation is 0.3 or more and 1.5 or less, more preferably more than 0.5 and less than 1.20.

Likewise, for further reduction of band-shaped defects on the resulting image, the toner particles according to the second exemplary embodiment are configured such that the coefficient of variation of the areas of Voronoi cells is 0.3 or more when a Voronoi tessellation is generated from the centroids of the islands in the sea-island structure therein. The coefficient of variation may be 0.3 or more and 1.5 or less, preferably more than 0.5 and less than 1.20.

The coefficient of variation of the areas of Voronoi cells can be determined as follows.

Cross-sections of toner particles are observed in the same way as in checking whether the toner particles have a sea-island structure.

In the cross-section of one toner particle, a Voronoi tessellation (a partition into regions closest to a given set of “seeds” by drawing a perpendicular bisector across line segments between adjacent seeds) is generated from the centroids of all islands, and the area of all resulting Voronoi cells is measured.

The centroid of an island is represented by x- and y-coordinates. The x- and y-coordinates are (a total of xᵢ)/n and (a total of yᵢ)/n, respectively, where n is the number of pixels present within the area of the island, and xᵢ and yᵢ are the x- and y-coordinates, respectively, of each pixel (i=1, 2, . . . , n).

This operation is repeated for 300 toner particles, and the arithmetic mean and standard deviation of the areas of Voronoi cells are calculated.

The coefficient of variation of the areas of Voronoi cells can be calculated according to the following equation:

Coefficient of variation of the areas of Voronoi cells={S1/K1},

where S1 and K1 denote the standard deviation and arithmetic mean, respectively, of the areas of the Voronoi cells generated from islands in the toner particles.

If, for example, the field of view includes ineligible toner particles (e.g., ones with no visible island therein) or an interfering black image around eligible toner particles, the analysis should be customized to exclude the regions other than eligible toner particles.

It is not critical how specifically to bring the coefficient of variation of the areas of Voronoi cells into the above ranges, but an example is to adjust the individual solubility parameter (SP) and weight-average molecular weight (Mw) of the amorphous and crystalline resins in the binder resins, described below, in a toner production process of the type that involves heating and mixing amorphous and crystalline resins or similar operations as in kneading and milling. In wet production of toner, such as emulsion aggregation, the control may alternatively be achieved by changing the ratio between a liquid dispersion of the amorphous resins and that of the crystalline resin at each time when adding the liquid dispersions of resin particles dropwise.

The toner particles may be single-layer ones or may be “core-shell” ones, i.e., toner particles formed by a core (core particle) and a coating that covers the core (shell layer).

The volume-average diameter (D50v) of the toner particles may be 2 μm or more and 10 μm or less, preferably 4 μm or more and 8 μm or less.

Average diameters and geometric standard deviations of the toner particles can be measured using Coulter Multisizer II (Beckman Coulter) and ISOTON-II electrolyte (Beckman Coulter).

The measurement starts with adding a sample weighing 0.5 mg or more and 50 mg or less to 2 ml of a 5% by mass aqueous solution of a surfactant (e.g., a sodium alkylbenzene sulfonate), which will serve as a dispersant. The resulting dispersion is added to 100 ml or more and 150 ml or less of the electrolyte.

The electrolyte with the suspended sample therein is sonicated for 1 minute using a sonicator, and the size distribution of particles having a diameter of 2 μm or more and 60 μm or less is measured using Coulter Multisizer II with an aperture size of 100 μm. The number of particles sampled is 50000.

On particle size segments (channels) divided based on the measured size distribution, the cumulative distribution of volume and that of frequency are plotted starting from the smallest diameter. In the plots, the particle diameters at which the cumulative sum is 16% are defined as volume diameter D16v and number diameter D16p. The particle diameters at which the cumulative sum is 50% are defined as the volume-average diameter D50v and cumulative number-average diameter D50p, and the particle diameters at which the cumulative sum is 84% are defined as volume diameter D84v and number diameter D84p.

Using these, the geometric standard deviation by volume (GSDv) is given by (D84v/D16v)^{1/2}, and that by number (GSDp) is given by (D84p/D16p)^{1/2}.

The average circularity of the toner particles may be 0.90 or more and 1.00 or less, preferably 0.92 or more and 0.98 or less.

The average circularity of the toner particles is given by (circumference of the equivalent circle)/(circumference) [(circumference of circles having the same projected area as particle images)/(circumference of projected images of the particles)]. Specifically, the average circularity of the toner particles is the value measured as follows.

A portion of the toner particles of interest is collected by aspiration in such a manner that it will form a flat stream, and this flat stream is photographed with a flash to capture the figures of the particles in a still image. The images of particles are analyzed using a flow particle-image analyzer (Spectris FPIA-3000), and the average circularity is determined from the results. The number of particles sampled in the determination of the average circularity is 4500.

If the toner contains external additives, the external additives are removed beforehand by dispersing the toner (developer) of interest in water containing a surfactant and then sonicating the resulting dispersion.

### Composition of the Toner Particles

The toner particles contain, for example, binder resins. Optionally, the toner particles may contain coloring agent(s), a release agent, and/or other additives.

### Binder Resins

The binder resins according to the first exemplary embodiment include amorphous resins and at least one crystalline resin, the amorphous resins including amorphous resin a1 and amorphous resin a2 and the crystalline resin including crystalline resin c1.

The binder resins according to the second exemplary embodiment include at least one amorphous resin and at least one crystalline resin. The amorphous resin may include amorphous resin a1 and amorphous resin a2, and the crystalline resin may include crystalline resin c1.

If, for example, the binder resins include three or more amorphous resins that meet the condition represented by formula (1), amorphous resin a1 is the resin having the smallest solubility parameter (SP), and amorphous resin a2 is the resin having the largest solubility parameter (SP).

If, for example, the binder resins include two or more crystalline resins, crystalline resin c1 is the most abundant one of the crystalline resins.

If, for example, the binder resins include two or more crystalline resins in equal proportions, the arithmetic mean solubility parameter of the two or more crystalline resins is used as SP (c1), or the solubility parameter of crystalline resin c1.

### Weight-Average Molecular Weights

The binder resins according to the first exemplary embodiment meet the condition represented by formula (1), where Mw (a1) is the weight-average molecular weight of amorphous resin a1, and Mw (a2) is that of amorphous resin a2. For further reduction of band-shaped defects on the resulting image, the binder resins may meet the condition represented by formula (1-2) or may even meet the condition represented by formula (1-3).

For further reduction of band-shaped defects on the resulting image, the binder resins according to the second exemplary embodiment may meet the condition represented by formula (1). The binder resins may meet the condition represented by formula (1-2) or may even meet the condition represented by formula (1-3).

10,000≤Mw(a2)−Mw(a1)≤150,000 (1)

15,000≤Mw(a2)−Mw(a1)≤140,000 (1-2)

30,000≤Mw(a2)−Mw(a1)≤100,000 (1-3)

For further reduction of band-shaped defects on the resulting image, the binder resins according to exemplary embodiments may be configured such that the weight-average molecular weight Mw (a1) of amorphous resin a1 is 7,000 or more and 30,000 or less. Mw (a1) may be 10,000 or more and 25,000 or less or may even be 12,000 or more and 22,000 or less.

Likewise, for further reduction of band-shaped defects on the resulting image, the binder resins according to exemplary embodiments may be configured such that the weight-average molecular weight Mw (a2) of amorphous resin a2 is 25,000 or more and 180,000 or less. Mw (a2) may be 30,000 or more and 150,000 or less or may even be 50,000 or more and 90,000 or less.

For further reduction of band-shaped defects on the resulting image, furthermore, the binder resins according to exemplary embodiments may be configured such that the weight-average molecular weight Mw (c1) of crystalline resin c1 is 8,000 or more and 100,000 or less. Mw (c1) may be 10,000 or more and 80,000 or less or may even be 12,000 or more and 60,000 or less.

The weight-average molecular weights can be measured using a gel permeation chromatograph (GPC) (HLC-8420 GPC, Tosoh) with Tosoh's TSKgel SuperHM-M column (15 cm) in THF as the eluate. A molecular-weight curve is prepared using monodisperse polystyrene standards, and comparing the measured data with this curve will give the weight-average molecular weight.

It is not critical how to make the weight-average molecular weights of the resins as illustrated above and meet the conditions represented by formulae (1) to (1-3), but examples include adjusting the proportions of the monomers used to form the resins, the crosslinking agent, etc.; adjusting the ratio between the monomers and the polymerization catalyst; and customizing polymerization parameters, such as the temperature and duration of polymerization.

### Solubility Parameters

The binder resins according to the first exemplary embodiment meet the condition represented by formula (2), where SP (a1) is the solubility parameter (SP) of amorphous resin a1, SP (a2) is that of amorphous resin a2, and SP (c1) is that of crystalline resin c1. For further reduction of band-shaped defects on the resulting image, the binder resins may meet the condition represented by formula (2-2). Preferably, the binder resins meet the condition represented by formula (2-3).

Likewise, for further reduction of band-shaped defects on the resulting image, the binder resins according to the second exemplary embodiment may meet the condition represented by formula (2). Preferably, the binder resins meet the condition represented by formula (2-2), more preferably that represented by formula (2-3).

|SP(a1)−SP(c1)|/|SP(a2)−SP(c1)|≤0.9 (2)

0.2≤|SP(a1)−SP(c1)|/|SP(a2)−SP(c1)|≤0.9 (2-2)

0.4≤|SP(a1)−SP(c1)|/|SP(a2)−SP(c1)|≤0.7 (2-3)

The binder resins according to exemplary embodiments may meet the condition represented by formula (3), preferably that represented by formula (3-2), more preferably that represented by formula (3-3) further reduction of band-shaped defects on the resulting image.

0.8≤|SP(a2)−SP(c1)|≤2.5 (3)

1.1≤|SP(a2)−SP(c1)|≤2.3 (3-2)

1.2≤|SP(a2)−SP(c1)|≤2.1 (3-3)

For the above formulae to be met more easily, the binder resins according to exemplary embodiments may be configured such that SP (a1) is 9.8 or more and 10.5 or less. SP (a1) may be 9.9 or more and 10.4 or less or may even be 9.95 or more and 10.3 or less.

Likewise, the binder resins according to exemplary embodiments may be configured such that SP (a2) is 10.1 or more and 11.5 or less for the above formulae to be met more easily. SP (a2) may be 10.3 or more and 11.30 or less or may even be 10.5 or more and 11.2 or less.

The binder resins according to exemplary embodiments, furthermore, may be configured such that SP (c1) is 8.6 or more and 10.2 or less for the above formulae to be met more easily. SP (c1) may be 8.7 or more and 10.0 or less or may even be 8.9 or more and 9.9 or less.

The solubility parameters (SPs) of the resins are those calculated according to Fedors (Polym. Eng. Sci., 14, 147 (1974)).

It is not critical how to make the solubility parameters (SPs) of the resins as illustrated above and meet the conditions represented by formulae (2) to (2-3), but an example is to customize the monomers used to form the resins and their proportions.

More specifically, the SP of a polyester binder resin, for example, can be increased by approaches like changing an aromatic diol, such as bisphenol A, to an aliphatic diol, such as propylene glycol or neopentyl glycol.

The SP of a polyester binder resin can also be increased by approaches like changing a dicarboxylic acid used as the acid component from an aromatic one, such as terephthalic acid, to an aliphatic one, such as sebacic acid.

As for a hybrid binder resin, or a binder resin having polyester resin and styrene-acrylic copolymer segments, its SP can be adjusted by modifying the SP of the polyester resin segment in a way as described above or by approaches like customizing the ratio between the polyester resin and styrene-acrylic copolymer segments.

Incidentally, the term amorphous resin herein refers to a resin that, in a thermal analysis by differential scanning calorimetry (DSC), only shows stepwise endothermic changes, instead of a clear endothermic peak. The resin is solid at room temperature and thermoplasticizes at temperatures equal to or higher than its glass transition temperature.

A crystalline resin, on the other hand, shows a clear endothermic peak rather than stepwise endothermic changes in differential scanning calorimetry (DSC).

Specifically, being a crystalline resin, for example, means its endothermic peak as measured at a heating rate of 10° C./min has a full width at half maximum of 10° C. or narrower, whereas an amorphous resin represents one with which the full width at half maximum is broader than 10° C. or that shows no clear endothermic peak.

The amorphous resins may be described as follows.

Examples of amorphous resins include known ones, such as amorphous polyester resins, amorphous vinyl resins (e.g., styrene-acrylic resins), epoxy resins, polycarbonate resins, and polyurethane resins. Of these, amorphous polyester resins and amorphous vinyl resins (styrene-acrylic resins in particular) are preferred, and amorphous polyester resins are more preferred.

A combination of amorphous polyester and styrene-acrylic resins may also be used. Amorphous resins having amorphous polyester resin and styrene-acrylic resin segments may also work.

### Amorphous Polyester Resin

An example of an amorphous polyester resin is a polycondensate of polycarboxylic acid(s) and polyhydric alcohol(s). Either commercially available or synthesized amorphous polyester resins may be used.

Examples of polycarboxylic acids include aliphatic dicarboxylic acids (e.g., oxalic acid, malonic acid, maleic acid, fumaric acid, citraconic acid, itaconic acid, glutaconic acid, succinic acid, alkenylsuccinic acids, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), and anhydrides and lower-alkyl (e.g., C1 to C5 alkyl) esters thereof. Of these, aromatic dicarboxylic acids are preferred.

A combination of a dicarboxylic acid and a crosslinked or branched carboxylic acid having three or more carboxylic groups may also be used. Examples of carboxylic acids having three or more carboxylic groups include trimellitic acid, pyromellitic acid, and anhydrides and lower-alkyl (e.g., C1 to C5 alkyl) esters thereof.

One polycarboxylic acid may be used alone, or two or more may be used in combination.

Examples of polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these, aromatic diols and alicyclic diols are preferred, and aromatic diols are more preferred.

A combination of a diol and a crosslinked or branched polyhydric alcohol having three or more hydroxyl groups may also be used. Examples of polyhydric alcohols having three or more hydroxyl groups include glycerol, trimethylolpropane, and pentaerythritol.

One polyhydric alcohol may be used alone, or two or more may be used in combination.

The production of the amorphous polyester resin, if produced, can be by known methods. A specific example is to polymerize the raw materials at a temperature of 180° C. or above and 230° C. or below, optionally at reduced pressure so that the water and alcohol produced with the condensation will leave. A high-boiling solvent may be added as a solubilizer to make soluble any raw-material monomer insoluble or not miscible with the other(s) at the reaction temperature. The solubilizer, if used, is removed by distillation during the polycondensation. In the copolymerization, any monomer not miscible with the other(s) may be condensed with the counterpart acid(s) or alcohol(s) before the polycondensation.

As well as native ones, modified forms are also examples of amorphous polyester resins. A modified amorphous polyester resin is one that has a non-ester linking group or a non-polyester resin component bound by covalent, ionic, or any other form of bonding. An example is a terminally modified one obtained by reacting a terminally functionalized amorphous polyester resin, for example functionalized with an isocyanate group, with an active hydrogen compound.

The amorphous polyester resin may constitute, as a percentage to all binder resins, 60% by mass or more and 98% by mass or less, preferably 65% by mass or more and 96% by mass or less, more preferably 70% by mass or less and 95% by mass or less.

### Styrene-Acrylic Resin

A styrene-acrylic resin is a copolymer formed by copolymerizing at least a styrene monomer (monomer having a styrene backbone) and a (meth)acrylic monomer (monomer having a (meth)acrylic group, preferably a (meth)acryloxy group). Examples of styrene-acrylic resins include copolymers of styrene monomer(s) and (meth)acrylate monomer(s).

The acrylic resin moiety of a styrene-acrylic resin is a substructure formed by polymerizing an acrylic monomer, methacrylic monomer, or both. The expression “(meth)acrylic” encompasses both “acrylic” and “methacrylic,” and the expression “(meth)acrylate” encompasses both an “acrylate” and a “methacrylate.”

Examples of styrene monomers include styrene, α-methylstyrene, meta-chlorostyrene, para-chlorostyrene, para-fluorostyrene, para-methoxystyrene, meta-tert-butoxystyrene, para-tert-butoxystyrene, para-vinylbenzoic acid, and para-methyl-α-methylstyrene. One styrene monomer may be used alone, or two or more may be used in combination.

Examples of (meth)acrylic monomers include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, isobornyl (meth)acrylate, 2-hydroxyethyl (meth)acrylate, hydroxypropyl (meth)acrylate, and 4-hydroxybutyl (meth)acrylate. One (meth)acrylic monomer may be used alone, or two or more may be used in combination.

The ratio between the styrene and (meth)acrylic monomers in the polymerization may be between 70:30 and 95:5 (styrene:(meth)acrylic) on a mass basis.

The styrene-acrylic resin may have crosslinks. A crosslinked styrene-acrylic resin can be produced by, for example, copolymerizing a styrene monomer, a (meth)acrylic monomer, and a crosslinking monomer. The crosslinking monomer can be of any kind, but an example is a (meth)acrylate compound having two or more functional groups.

The production of the styrene-acrylic resin can be by any method. Techniques such as solution polymerization, precipitation polymerization, suspension polymerization, bulk polymerization, and emulsion polymerization can be used. The polymerization reactions can be done by known processes (batch, semicontinuous, continuous, etc.).

The styrene-acrylic resin may constitute, as a percentage to all binder resins, 0% by mass or more and 20% by mass or less, preferably 1% by mass or more and 15% by mass or less, more preferably 2% by mass or less and 10% by mass or less.

### Amorphous Resin Having Amorphous Polyester Resin and Styrene-Acrylic Copolymer Segment (Hereinafter Also Referred to as “a Hybrid Amorphous Resin”)

A hybrid amorphous resin is a resin in which an amorphous polyester resin segment and a styrene-acrylic resin segment are chemically bound together.

Examples of hybrid amorphous resins include those having a polyester backbone and styrene-acrylic side chains chemically bound to the backbone; those having a styrene-acrylic backbone and polyester side chains chemically bound to the backbone; those having a backbone formed by polyester and styrene-acrylic resins chemically bound together; and those having a backbone formed by polyester and styrene-acrylic resins chemically bound together and polyester and/or styrene-acrylic side chains chemically bound to the backbone.

The amorphous polyester and styrene-acrylic resins in their respective segments are not described; they are as described above.

Preferably, the amorphous resins include at least one of an amorphous polyester resin or an amorphous resin having polyester resin and styrene-acrylic resin segments.

The combined percentage of the polyester resin and styrene-acrylic resin segments to the hybrid amorphous resin as a whole may be 80% by mass or more, preferably 90% by mass or more, more preferably 95% by mass or more, even more preferably 100% by mass.

In the hybrid amorphous resin, furthermore, the percentage of the styrene-acrylic resin segment to the polyester resin and styrene-acrylic resin segments combined may be 20% by mass or more and 60% by mass or less, preferably 25% by mass or more and 55% by mass or less, more preferably 30% by mass or more and 50% by mass or less.

Examples of how to produce a hybrid amorphous resin include the following (i) to (iii).

(i) The polyester resin segment is produced by polycondensation between polyhydric alcohol(s) and polycarboxylic acid(s). Then the monomers that will form the styrene-acrylic resin segment are polymerized by addition polymerization.

(ii) The styrene-acrylic resin segment is produced by addition polymerization of monomers capable of it. Then polyhydric alcohol(s) and polycarboxylic acid(s) are polycondensed.

(iii) Polyhydric alcohol(s) and polycarboxylic acid(s) are polycondensed, and monomers capable of addition polymerization are polymerized by addition polymerization at the same time.

The hybrid amorphous resin may constitute, as a percentage to all binder resins, 60% by mass or more and 98% by mass or less, preferably 65% by mass or more and 96% by mass or less, more preferably 70% by mass or more and 95% by mass or less.

The amorphous resins may have the following characteristics.

The glass transition temperature (Tg) of the amorphous resins may be 50° C. or above and 80° C. or below, preferably 50° C. or above and 70° C. or below.

The glass transition temperature can be determined from the DSC curve, measured by differential scanning calorimetry (DSC), and more specifically is the “extrapolated initial temperature of glass transition” as in the methods for determining glass transition temperatures set forth in JIS K7121-1987 “Testing Methods for Transition Temperatures of Plastics.”

The crystalline resin may be as described below.

Examples of crystalline resins include known ones, such as crystalline polyester resins and crystalline vinyl resins (e.g., polyalkylene resins and long-chain alkyl (meth)acrylate resins). Of these, using a crystalline polyester resin may help give the toner higher mechanical strength and achieve better fixation at low temperatures.

### Crystalline Polyester Resin

An example of a crystalline polyester resin is a polycondensate of polycarboxylic acid(s) and polyhydric alcohol(s). Either commercially available or synthesized crystalline polyester resins may be used.

Crystalline polyester resins made with linear aliphatic polymerizable monomers form a crystal structure more easily than those made with aromatic polymerizable monomers.

Examples of polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids, such as phthalic acid, isophthalic acid, terephthalic acid, and naphthalene-2,6-dicarboxylic acid), and anhydrides and lower-alkyl (e.g., C1 to C5 alkyl) esters thereof.

A combination of a dicarboxylic acid and a crosslinked or branched carboxylic acid having three or more carboxylic groups may also be used. Examples of carboxylic acids having three or more carboxylic groups include aromatic carboxylic acids (e.g., 1,2,3-benzenetricarboxylic acid, 1,2,4-benzenetricarboxylic acid, and 1,2,4-naphthalenetricarboxylic acid) and anhydrides and lower-alkyl (e.g., C1 to C5 alkyl) esters thereof.

A combination of an aforementioned dicarboxylic acid and a dicarboxylic acid having a sulfonic acid group or an ethylenic double bond may also be used.

One polycarboxylic acid may be used alone, or two or more may be used in combination.

Examples of polyhydric alcohols include aliphatic diols (e.g., C7 to C20 linear aliphatic diols). Examples of aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these, 1,8-octanediol, 1,9-nonanediol, and 1,10-decanediol are preferred.

A combination of a diol and a crosslinked or branched alcohol having three or more hydroxyl groups may also be used. Examples of alcohols having three or more hydroxyl groups include glycerol, trimethylolethane, trimethylolpropane, and pentaerythritol.

One polyhydric alcohol may be used alone, or two or more may be used in combination.

The polyhydric alcohol(s) may include 80 mol % or more aliphatic diol(s), preferably 90 mol % or more aliphatic diol(s).

The production of the crystalline polyester resin, if produced, can be by, for example, known methods, like that of the amorphous polyester resin.

The crystalline polyester resin may be a polymer of linear aliphatic α,ω-dicarboxylic acid(s) and linear aliphatic α,ω-diol(s).

The linear aliphatic α,ω-dicarboxylic acid(s) may be one(s) having a C3 to C14 alkylene group between the two carboxy groups. Preferably, the number of carbon atoms in the alkylene group is 4 or more and 12 or less, more preferably 6 or more and 10 or less.

Examples of linear aliphatic α,ω-dicarboxylic acids include succinic acid, glutaric acid, adipic acid, 1,6-hexanedicarboxylic acid (commonly known as suberic acid), 1,7-heptanedicarboxylic acid (commonly known as azelaic acid), 1,8-octanedicarboxylic acid (commonly known as sebacic acid), 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid. Of these, 1,6-hexanedicarboxylic acid, 1,7-heptanedicarboxylic acid, 1,8-octanedicarboxylic acid, 1,9-nonanedicarboxylic acid, and 1,10-decanedicarboxylic acid are preferred.

One linear aliphatic α,ω-dicarboxylic acid may be used alone, or two or more may be used in combination.

The linear aliphatic α,ω-diol(s) may be one(s) having a C3 to C14 alkylene group between the two hydroxy groups. Preferably, the number of carbon atoms in the alkylene group is 4 or more and 12 or less, more preferably 6 or more and 10 or less.

Examples of linear aliphatic α,ω-diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, and 1,18-octadecanediol. Of these, 1,6-hexanediol, 1,7-heptanediol, 1,8-octanediol, 1,9-nonanediol, and 1,10-decanediol are preferred.

One linear aliphatic α,ω-diol may be used alone, or two or more may be used in combination.

The polymer of linear aliphatic α,ω-dicarboxylic acid(s) and linear aliphatic α,ω-diol(s) may be that of at least one selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one selected from the group consisting of 1,6-hexanediol, 1,7-heptanediol, 1,8-octanediol, 1,9-nonanediol, and 1,10-decanediol.

The binder resin content may be 40% by mass or more and 96% by mass or less, preferably 50% by mass or more and 93% by mass or less, more preferably 60% by mass or more and 90% by mass or less of the toner particles as a whole.

For further reduction of band-shaped defects on the resulting image, the crystalline resin c1 content as a percentage to the toner particles may be 2% by mass or more and 25% by mass or less. Preferably, this crystalline resin c1 content is 3% by mass or more and 20% by mass or less, more preferably 4% by mass or more and 15% by mass or less.

For further reduction of band-shaped defects on the resulting image, the crystalline resin c1 content as a percentage to the amorphous resins may be 2% by mass or more and 40% by mass or less. Preferably, this crystalline resin c1 content is 3% by mass or more and 35% by mass or less, more preferably 4% by mass or more and 30% by mass or less.

For further reduction of band-shaped defects on the resulting image, the crystalline resin c1 content as a percentage to all crystalline resins may be 60% by mass or more. Preferably, this crystalline resin c1 content is 70% by mass or more, more preferably 80% by mass or more and 100% by mass or less.

For further reduction of band-shaped defects on the resulting image, the ratio by mass between amorphous resins a1 and a2 (a1/a2) may be between 0.2 and 10.0. Preferably, this ratio is between 0.5 and 9.0, more preferably between 0.8 and 8.0.

For further reduction of band-shaped defects on the resulting image, the total amorphous resins a1 and a2 content as a percentage to all amorphous resins may be 80% by mass or more. Preferably, this content is 85% by mass or more, more preferably 90% by mass or more and 100% by mass or less.

For further reduction of band-shaped defects on the resulting image, furthermore, the amorphous resin content as a percentage to the toner particles may be 35% by mass or more and 95% by mass or less. Preferably, this amorphous resin content is 40% by mass or more and 92% by mass or less, more preferably 45% by mass or more and 90% by mass or less.

The ratio by mass between the crystalline and amorphous resins (crystalline/amorphous) may be 2/98 or more and 50/50 or less, preferably 4/96 or more and 40/60 or less.

### Coloring Agent

Examples of coloring agents include pigments, such as carbon black, chrome yellow, Hansa yellow, benzidine yellow, threne yellow, quinoline yellow, pigment yellow, permanent orange GTR, pyrazolone orange, Vulcan orange, Watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, Calco oil blue, methylene blue chloride, phthalocyanine blue, pigment blue, phthalocyanine green, and malachite green oxalate; and dyes, such as acridine, xanthene, azo, benzoquinone, azine, anthraquinone, thioindigo, dioxazine, thiazine, azomethine, indigo, phthalocyanine, aniline black, polymethine, triphenylmethane, diphenylmethane, and thiazole dyes.

One coloring agent may be used alone, or two or more may be used in combination.

Surface-treated coloring agents may optionally be used, and a combination of a coloring agent and a dispersant may also be used. It is also possible to use multiple coloring agents in combination.

The coloring agent content may be 1% by mass or more and 30% by mass or less, preferably 3% by mass or more and 15% by mass or less, of the toner particles as a whole.

### Release Agent

Examples of release agents include hydrocarbon waxes; natural waxes, such as carnauba wax, rice wax, and candelilla wax; synthesized or mineral/petroleum waxes, such as montan wax; and ester waxes, such as fatty acid esters and montanates. Other release agents may also be used.

The melting temperature of the release agent may be 50° C. or above and 140° C. or below, preferably 60° C. or above and 120° C. or below.

The melting temperature of the release agent is the “peak melting temperature” as in the methods for determining melting temperatures set forth in JIS K 7121-1987 “Testing Methods for Transition Temperatures of Plastics” and is determined from the DSC curve, measured by differential scanning calorimetry (DSC).

The release agent content may be 1% by mass or more and 20% by mass or less, preferably 4% by mass or more and 15% by mass or less, of the toner particles as a whole.

### Other Additives

Examples of other additives include known additives, such as magnetic substances, charge control agents, and inorganic powders. Such additives are contained in the toner particles as internal additives.

### External Additives

An example of an external additive is inorganic particles. Examples of inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surface of the externally added inorganic particles may have been rendered hydrophobic. The hydrophobic treatment is done by, for example, immersing the inorganic particles in a hydrophobizing agent. The hydrophobizing agent can be of any kind, but examples include silane coupling agents, silicone oil, titanate coupling agents, and aluminum coupling agents. One such agent may be used alone, or two or more may be used in combination. The amount of the hydrophobizing agent is usually, for example, 1 part by mass or more and 60 parts by mass or less per 100 parts by mass of the inorganic particles.

Materials like resin particles (particles of polystyrene, polymethyl methacrylate, melamine resins, etc.) and active cleaning agents (e.g., metal salts of higher fatty acids, typically zinc stearate, and particles of fluoropolymers) are also examples of external additives.

The amount of the external additive(s) may be 0.01% by mass or more and 10.0% by mass or less, preferably 0.1% by mass or more and 6.0% by mass or less, of the toner particles.

### Production of the Toner

The toner according to exemplary embodiments can be obtained by producing the toner particles and then adding external additives to the toner particles.

The production of the toner particles can be either by a dry process (e.g., kneading and milling) or by a wet process (e.g., aggregation and coalescence, suspension polymerization, or dissolution and suspension). Any known dry or wet process may be used.

The following describes an example of how to produce the toner particles by kneading and milling by way of example.

Kneading and milling is a production process in which, for example, binder resins including amorphous and crystalline resins and a coloring agent are melted and kneaded together, then the kneaded mixture is milled, and then the milled grains are classified to give toner particles. The process includes, for example, kneading, in which ingredients including binder resins and a coloring agent are melted and kneaded together; cooling, in which the molten mixture is cooled; milling, in which the cooled mixture is milled; and classification, in which the milled grains are classified.

The following describes the details of a production of toner particles by kneading and milling.

### Kneading

Ingredients including binder resins (including amorphous and crystalline resins) and a coloring agent are melted and kneaded together.

Examples of kneaders that can be used include three-roll, single-screw, twin-screw, and Banbury-mixer kneaders.

The temperature at which the materials are melted can be determined according to the binder resins and coloring agent used, their proportions, etc.

### Cooling

The kneaded mixture is then cooled.

An example of a cooling method is the use of a combination of rollers and a belt therebeneath, for instance, with circulating cold water or brine. If this method is used, the rate of cooling is determined by the speed of the rollers, the flow rate of the water or brine, the supply rate of the kneaded mixture, the thickness of the slab on which the mixture is rolled, etc.

### Milling

The cooled mixture is then milled into particles.

A mechanical mill or jet mill, for example, is used.

### Classification

Optionally, the product of milling (particles) may be classified to give the toner particles the desired average diameter.

A centrifugal, inertial, or any other commonly used classifier is used to eliminate undersized powder (particles smaller than the desired range of diameters) and oversized powder (particles larger than the desired range of diameters).

### Hot-Air Blow

Optionally, the classified particles may be blown with hot air to give the toner particles the desired circularity.

Adding external additives to the resulting toner particles, which are dry, and mixing them together, for example, will give toner according to exemplary embodiments. The mixing may be done using, for example, a V-blender, Henschel mixer, or Lödige mixer. Optionally, coarse particles may be removed from the toner, for example using a vibrating sieve or air-jet sieve.

### Electrostatic Charge Image Developer

An electrostatic charge image developer according to an exemplary embodiment contains at least toner according to the above exemplary embodiment(s).

The electrostatic charge image developer according to this exemplary embodiment may be a one-component developer, which is substantially toner according to the above exemplary embodiment(s), or may be a two-component developer, which is a mixture of the toner and a carrier.

The carrier can be of any kind and can be a known one. Examples include a coated carrier, formed by a core magnetic powder and a coating resin on its surface; a magnetic powder-dispersed carrier, formed by a matrix resin and a magnetic powder dispersed therein; and a resin-impregnated carrier, which is a porous magnetic powder impregnated with resin.

The particles as a component of a magnetic powder-dispersed or resin-impregnated carrier can serve as the core material; a carrier obtained by coating the surface of them with resin may also be used.

Examples of magnetic powders include powders of magnetic metals, such as iron, nickel, and cobalt, and powders of magnetic oxides, such as ferrite and magnetite.

Examples of resins, for use as a coating or matrix, include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins, which contain organosiloxane bonds, and their modified forms, fluoropolymers, polyester, polycarbonate, phenolic resins, and epoxy resins.

The coating or matrix resin may contain additives, such as electrically conductive particles.

Examples of electrically conductive particles include particles of metals, such as gold, silver, and copper, and particles of carbon black, titanium oxide, zinc oxide, tin oxide, barium sulfate, aluminum borate, potassium titanate, etc.

When coating the surface of the core material with resin, an exemplary way is to coat the surface with a solution in which the coating resin is dissolved in any kind of solvent optionally with additives, or a coating-layer solution. The solvent can be of any kind and can be selected considering, for example, the coating resin used and suitability for coating.

Specific examples of how to provide the resin coating include dipping, i.e., immersing the core material in the coating-layer solution; spraying, i.e., applying a mist of the coating-layer solution onto the surface of the core material; fluidized bed coating, i.e., applying a mist of the coating-layer solution to core material floated on a stream of air; and kneader-coater coating, i.e., mixing the carrier core material and the coating-layer solution in a kneader-coater and removing the solvent.

For a two-component developer, the mix ratio (by mass) between the toner and the carrier may be between 1:100 (toner:carrier) and 30:100. Preferably, the mix ratio is between 3:100 and 20:100.

### Image Forming Apparatus/Image Forming Method

The following describes an image forming apparatus/image forming method according to an exemplary embodiment.

An image forming apparatus according to this exemplary embodiment includes an image carrier; a charging component that charges the surface of the image carrier; an electrostatic charge image creating component that creates an electrostatic charge image on the charged surface of the image carrier; a developing component that contains an electrostatic charge image developer and develops, using the electrostatic charge image developer, the electrostatic charge image on the surface of the image carrier to form a toner image; a transfer component that transfers the toner image on the surface of the image carrier to the surface of a recording medium; and a fixing component that fixes the toner image on the surface of the recording medium. The electrostatic charge image developer is an electrostatic charge developer according to the above exemplary embodiment.

The image forming apparatus according to this exemplary embodiment performs an image forming method that includes charging the surface of an image carrier; creating an electrostatic charge image on the charged surface of the image carrier; developing, using an electrostatic charge image developer according to the above exemplary embodiment, the electrostatic charge image on the surface of the image carrier to form a toner image; transferring the toner image on the surface of the image carrier to the surface of a recording medium; and fixing the toner image on the surface of the recording medium (image forming method according to this exemplary embodiment).

The configuration of the image forming apparatus according to this exemplary embodiment can be applied to well-known types of image forming apparatuses, including a direct-transfer image forming apparatus, which forms a toner image on the surface of an image carrier and transfers it directly to a recording medium; an intermediate-transfer image forming apparatus, which forms a toner image on the surface of an image carrier, transfers it to the surface of an intermediate transfer body (first transfer), and then transfers the toner image on the surface of the intermediate transfer body to the surface of a recording medium (second transfer); an image forming apparatus having a cleaning component that cleans the surface of the image carrier between the transfer of the toner image and charging; and an image forming apparatus having a static eliminator that removes static electricity from the surface of the image carrier by irradiating the surface with antistatic light between the transfer of the toner image and charging.

The transfer component of an intermediate-transfer apparatus may include, for example, an intermediate transfer body, the surface of which is for a toner image to be transferred to; a first transfer component, which transfers the toner image formed on the image carrier to the surface of the intermediate transfer body (first transfer); and a second transfer component, which transfers the toner image on the surface of the intermediate transfer body to the surface of a recording medium (second transfer).

Part of the image forming apparatus according to this exemplary embodiment, e.g., a portion including the developing component, may have a cartridge structure, i.e., a structure that allows the part to be detached from and attached to the image forming apparatus (or may be a process cartridge). An example of a process cartridge is one that includes a developing component that contains an electrostatic charge image developer according to the above exemplary embodiment.

The following describes an example of an image forming apparatus according to this exemplary embodiment, although this is not the only possible form. Some of its structural elements are described with reference to a drawing.

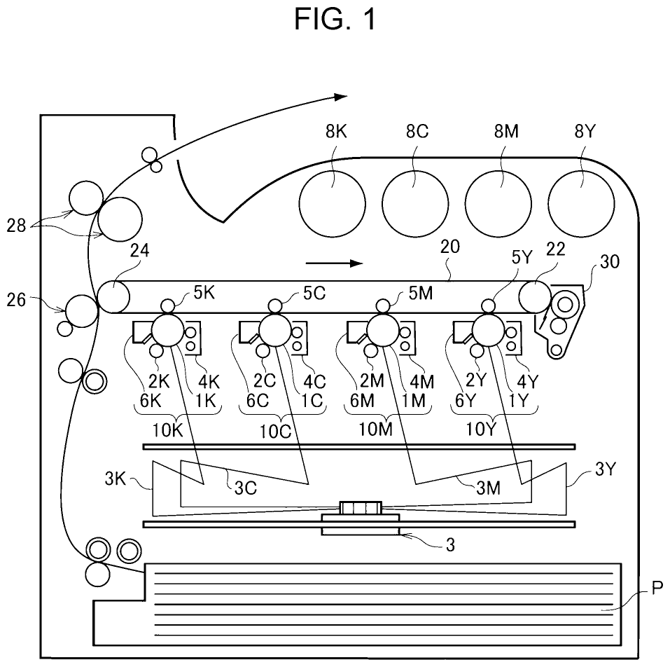

FIG. 1 is a schematic view of the structure of an image forming apparatus according to this exemplary embodiment.

The image forming apparatus illustrated in FIG. 1 includes first to fourth electrophotographic image forming units 10Y, 10M, 10C, and 10K (image forming component) that produce images in the colors of yellow (Y), magenta (M), cyan (C), and black (K), respectively, based on color-separated image data. These image forming units (hereinafter also referred to simply as “units”) 10Y, 10M, 10C, and 10K are arranged in a horizontal row with a predetermined distance therebetween. The units 10Y, 10M, 10C, and 10K may be process cartridges, i.e., units that can be detached from and attached to the image forming apparatus.

Above the units 10Y, 10M, 10C, and 10K in the drawing extends an intermediate transfer belt 20 as an intermediate transfer body, passing through each unit. The intermediate transfer belt 20 is wound over a drive roller 22 (right in the drawing) and a support roller 24 (left in the drawing) spaced apart from each other, with the rollers touching the inner surface of the intermediate transfer belt 20, and is driven by them to run in the direction from the first unit 10Y to the fourth unit 10K. The support roller 24 is forced by a spring or similar mechanism, not illustrated in the drawing, to go away from the drive roller 22, thereby placing tension on the intermediate transfer belt 20 wound over the two rollers. On the image-carrying side of the intermediate transfer belt 20 is a cleaning device 30 for the intermediate transfer belt 20, facing the drive roller 22.

The units 10Y, 10M, 10C, and 10K have developing devices (developing component) 4Y, 4M, 4C, and 4K, to which toners in the four colors of yellow, magenta, cyan, and black, respectively, are delivered from toner cartridges 8Y, 8M, 8C, and 8K.

Because the first to fourth units 10Y, 10M, 10C, and 10K are equivalent in structure, the following describes the first one 10Y, located upstream of the others in the direction of running of the intermediate transfer belt 20 and forms a yellow image, on behalf of the four. The second to fourth units 10M, 10C, and 10K are not described; they have structural elements equivalent to those of the first unit 10Y, and these elements are designated with the same numerals as in the first unit 10Y but with the letters M (for magenta), C (for cyan), and K (for black), respectively, in place of Y (for yellow).

The first unit 10Y has a photoreceptor 1Y that acts as an image carrier. Around the photoreceptor 1Y are a charging roller (example of a charging component) 2Y that charges the surface of the photoreceptor 1Y to a predetermined potential; an exposure device (example of an electrostatic charge image creating component) 3 that irradiates the charged surface with a laser beam 3Y produced on the basis of a color-separated image signal to create an electrostatic charge image there; a developing device (example of a developing component) 4Y that supplies charged toner to the electrostatic charge image to develop the electrostatic charge image; a first transfer roller (example of a first transfer component) 5Y that transfers the developed toner image to the intermediate transfer belt 20; and a photoreceptor cleaning device (example of a cleaning component) 6Y that removes residual toner off the surface of the photoreceptor 1Y after the first transfer, arranged in this order.

The first transfer roller 5Y is inside the intermediate transfer belt 20 and faces the photoreceptor 1Y. Each of the first transfer rollers 5Y, 5M, 5C, and 5K is connected to a bias power supply (not illustrated) that applies a first transfer bias to the roller. Each bias power supply is controlled by a controller, not illustrated in the drawing, to change the magnitude of the transfer bias it applies to the corresponding first transfer roller.

The formation of a yellow image at the first unit 10Y may be as described below.

First, before the image formation, the charging roller 2Y charges the surface of the photoreceptor 1Y to a potential of −600 V to −800 V.

The photoreceptor 1Y is a stack of an electrically conductive substrate (e.g., having a volume resistivity at 20° C. of 1×10⁻⁶ Ω·cm or less) and a photosensitive layer thereon. The photosensitive layer is of high electrical resistance (has the typical resistance of resin) in its normal state, but when it is irradiated with a laser beam 3Y, the resistivity of the irradiated portion changes. Thus, a laser beam 3Y is emitted using the exposure device 3 onto the charged surface of the photoreceptor 1Y in accordance with data for the yellow image sent from a controller, not illustrated in the drawing. The laser beam 3Y hits the photosensitive layer on the surface of the photoreceptor 1Y, creating an electrostatic charge image as a pattern for the yellow image on the surface of the photoreceptor 1Y.

The electrostatic charge image is an image created on the surface of the photoreceptor 1Y by electrical charging and is a so-called negative latent image; it is created as a result of the charge on the surface of the photoreceptor 1Y flowing away in the irradiated portion of the photosensitive layer in response to a resistivity decrease caused by the exposure to the laser beam 3Y while staying in the portion of the photosensitive layer not irradiated with the laser beam 3Y.

The electrostatic charge image created on the photoreceptor 1Y is moved to a predetermined development point as the photoreceptor 1Y rotates. At this development point, the electrostatic charge image on the photoreceptor 1Y is visualized (developed) into a toner image by the developing device 4Y.

Inside the developing device 4Y is an electrostatic charge image developer that contains, for example, at least yellow toner and a carrier. The yellow toner is on a developer roller (example of a developer carrier) and has been triboelectrically charged with the same polarity as the charge on the photoreceptor 1Y (negative) as a result of being stirred inside the developing device 4Y. As the surface of the photoreceptor 1Y passes through the developing device 4Y, the yellow toner electrostatically adheres to the uncharged, latent-image area of the surface of the photoreceptor 1Y and develops the latent image. The photoreceptor 1Y, now having a yellow toner image thereon, then continues rotating at a predetermined speed, transporting the toner image developed thereon to a predetermined first transfer point.

After the arrival of the yellow toner image on the photoreceptor 1Y at the first transfer point, a first transfer bias is applied to the first transfer roller 5Y, and an electrostatic force acts on the toner image in the direction from the photoreceptor 1Y toward the first transfer roller 5Y to cause the toner image to be transferred from the photoreceptor 1Y to the intermediate transfer belt 20. The applied transfer bias has the (+) polarity, opposite the polarity of the toner (−), and its amount has been controlled by a controller (not illustrated). For example, for the first unit 10Y, it has been controlled to +10 μA.

Residual toner on the photoreceptor 1Y is removed and collected at the photoreceptor cleaning device 6Y.

The first transfer biases applied to the first transfer rollers 5M, 5C, and 5K of the second, third, and fourth units 10M, 10C, and 10K have also been controlled in the same way as that at the first unit 10Y.

The intermediate transfer belt 20 to which a yellow toner image has been transferred at the first unit 10Y in this way is then transported passing through the second to fourth units 10M, 10C, and 10K sequentially, and toner images in the respective colors are overlaid to complete multilayer transfer.

The intermediate transfer belt 20 that has passed through the first to fourth units and thereby completed multilayer transfer of toner images in four colors then reaches a second transfer section formed by the intermediate transfer belt 20, the support roller 24, which touches the inner surface of the intermediate transfer belt 20, and a second transfer roller (example of a second transfer component) 26, which is on the image-carrying side of the intermediate transfer belt 20. Recording paper (example of a recording medium) P is fed to the point of contact between the second transfer roller 26 and the intermediate transfer belt 20 in a timed manner by a feeding mechanism, and a second transfer bias is applied to the support roller 24. The applied transfer bias has the (−) polarity, the same as the polarity of the toner (−), and an electrostatic force acts on the toner image in the direction from the intermediate transfer belt 20 toward the recording paper P to cause the toner image to be transferred from the intermediate transfer belt 20 to the recording paper P. The amount of the second transfer bias has been controlled and is determined in accordance with the resistance detected by a resistance detector (not illustrated) that detects the electrical resistance of the second transfer section.

After that, the recording paper P is sent to the point of pressure contact (nip) between a pair of fixing rollers at a fixing device (example of a fixing component) 28, and the toner image is fixed on the recording paper P there to give a fixed image.

The recording paper P to which the toner image is transferred can be, for example, a piece of ordinary printing paper for copiers, printers, etc., of electrophotographic type. Recording media such as overhead-projector (OHP) sheets may also be used.

The use of recording paper P having a smooth surface may help further improve the smoothness of the surface of the fixed image. For example, coated paper, which is paper with a coating, for example of resin, on its surface, or art paper for printing may be used.

The recording paper P with a completely fixed color image thereon is transported to an ejection section to finish the formation of a color image.

### Process Cartridge/Toner Cartridge

The following describes a process cartridge according to an exemplary embodiment.

A process cartridge according to this exemplary embodiment is one attachable to and detachable from an image forming apparatus and includes a developing component that contains an electrostatic charge image developer according to the above exemplary embodiment and develops, using the electrostatic charge image developer, an electrostatic charge image created on the surface of an image carrier to form a toner image.

This is not the only possible configuration of a process cartridge according to this exemplary embodiment. The process cartridge may optionally have at least one extra component selected from an image carrier, a charging component, an electrostatic charge image creating component, a transfer component, etc., besides the developing component.

The following describes an example of a process cartridge according to this exemplary embodiment, although this is not the only possible form. Some of its structural elements are described with reference to a drawing.

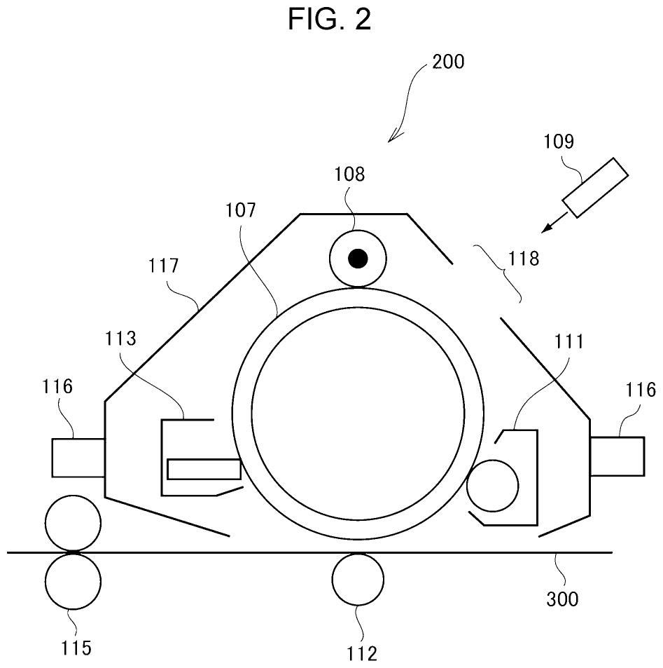

FIG. 2 is a schematic view of the structure of a process cartridge according to this exemplary embodiment.

The process cartridge 200 illustrated in FIG. 2 is a cartridge containing, for example, a photoreceptor 107 (example of an image carrier) and a charging roller 108 (example of a charging component), a developing device 111 (example of a developing component), and a photoreceptor cleaning device 113 (example of a cleaning component) arranged around the photoreceptor 107, all held together in a housing 117 having attachment rails 116 and an opening 118 for exposure to light.

FIG. 2 also illustrates an exposure device (example of an electrostatic charge image creating component) 109, a transfer device (example of a transfer component) 112, a fixing device (example of a fixing component) 115, and recording paper (example of a recording medium) 300.

The following describes a toner cartridge according to this exemplary embodiment.

A toner cartridge according to this exemplary embodiment is one attachable to and detachable from an image forming apparatus and contains toner according to the above exemplary embodiment. A toner cartridge is a cartridge that stores replenishment toner for a developing component placed inside an image forming apparatus.

The image forming apparatus illustrated in FIG. 1 has toner cartridges 8Y, 8M, 8C, and 8K attachable to and detachable from it, and the developing devices 4Y, 4M, 4C, and 4K are connected to their corresponding toner cartridges (or the toner cartridges for their respective colors) by toner feed tubing, not illustrated in the drawing. When there is little toner in a toner cartridge, this toner cartridge is replaced.

### EXAMPLES

The following describes exemplary embodiments of the present disclosure in detail by providing examples, although the exemplary embodiments of the present disclosure are not limited to these examples. In the following description, “parts” and “%” are by mass unless stated otherwise.

Synthesis of Amorphous Resin a1-1
Terephthalic acid: 90 parts by mole
Fumaric acid: 10 parts by mole
A 2-mole propylene oxide adduct of bisphenol A: 95 parts by mole
Neopentyl glycol: 5 parts by mole

These materials are loaded into a flask equipped with a stirring device, a nitrogen inlet tube, a temperature sensor, and a rectifying column. The temperature is increased to 210° C. spending 1 hour, and 1 part of titanium tetraethoxide is added to 100 parts of the materials. The temperature is increased to 230° C. spending 0.5 hours while water is removed by distillation as it is formed. After 1 hour of dehydration condensation at that temperature, the reaction product is cooled. This will give amorphous resin a1-1, having a weight-average molecular weight (Mw) of 18,000 and an SP according to Fedors of 10.20.

Synthesis of Amorphous Resin a2-1
Terephthalic acid: 86 parts by mole
Fumaric acid: 10 parts by mole
Trimellitic anhydride: 4 parts by mole
A 2-mole propylene oxide adduct of bisphenol A: 15 parts by mole
A 2-mole ethylene oxide adduct of bisphenol A: 10 parts by mole
Propylene glycol: 75 parts by mole

These materials are loaded into a flask equipped with a stirring device, a nitrogen inlet tube, a temperature sensor, and a rectifying column. The temperature is increased to 210° C. spending 1 hour, and 1 part of titanium tetraethoxide is added to 100 parts of the materials. The temperature is increased to 230° C. spending 0.5 hours while water is removed by distillation as it is formed. After 2 hours of dehydration condensation at that temperature, the reaction product is cooled. This will give amorphous resin a2-1, having a weight-average molecular weight (Mw) of 65,000 and an SP according to Fedors of 10.98.

Synthesis of Amorphous Resin a2-2
Terephthalic acid: 96 parts by mole
Trimellitic anhydride: 4 parts by mole
A 2-mole propylene oxide adduct of bisphenol A: 95 parts by mole
Neopentyl glycol: 5 parts by mole

Amorphous resin a2-2 is obtained in the same way as amorphous resin a2-1 except that the materials are changed to the above.

Synthesis of Crystalline Resin c1-1
Sebacic acid: 202 parts
1,6-Hexanediol: 118 parts
Dibutyltin oxide (catalyst): 0.5 parts

These materials are put into a three-neck flask dried by heating, and, after the air in the flask is replaced with nitrogen gas to create an inert atmosphere, the materials are stirred under reflux for 5 hours at 180° C. by mechanical stirring. This will give crystalline resin c1-1, having a weight-average molecular weight (Mw) of 21000 and an SP according to Fedors of 9.19.

Synthesis of Amorphous Resins a1-2 to a1-8

Amorphous resins a1-2 to a1-8 are obtained in the same way as amorphous resin a1-1 except that the starting materials are changed according to the formula in Table 1. Table 1 presents the SP and Mw of the resins.

Synthesis of Amorphous Resins a2-2 to a2-12

Amorphous resins a2-2 to a2-12 are obtained in the same way as amorphous resin a2-1 except that the starting materials are changed according to the formula in Table 1. Table 1 presents the SP and Mw of the resins.

Synthesis of Crystalline Resins c1-2 to c1-4

Crystalline resins c1-2 to c1-4 are obtained in the same way as crystalline resin c1-1 except that the starting materials are changed according to the formula in Table 2. Table 2 presents the SP and Mw of the resins.

The abbreviations in Table 1 stand for the following compounds. In Table 1, a blank cell indicates that material is not used.
TPA: Terephthalic acid
IPA: Isophthalic acid
AA: Adipic acid
TMA: Trimellitic anhydride
BPA-2PO: A 2-mole propylene oxide adduct of bisphenol A
BPA-3PO: A 3-mole propylene oxide adduct of bisphenol A
BPA-2EO: A 2-mole ethylene oxide adduct of bisphenol A
NPG: Neopentyl glycol
PG: Propylene glycol

### Example 1

Amorphous polyester resin a1-1: 60 parts
Amorphous polyester resin a2-1: 21 parts
Crystalline polyester resin c1-1: 7 parts
Coloring agent 1 (carbon black, Mitsubishi Chemical #25): 7 parts
Wax (paraffin wax, Nippon Seiro HNP9): 5 parts

These materials are mixed together in a Henschel mixer (FM75L, Nippon Coke & Engineering), then the mixture is kneaded through a twin-screw extruder (TEM-48SS, Shibaura Machine) at a temperature of 110° C. and a screw rotational speed of 250 rpm, and the resulting mass is rolled and cooled. The cooled mass is shredded in a hammer mill, the resulting grains are pulverized in a jet mill (AFG, Hosokawa Micron), and the resulting particles are classified using an elbow-jet classifier (EJ-LABO, Nittetsu Mining), giving toner particles 1.
Toner particles 1: 100 parts
Sol-gel silica particles (number-average diameter=120 nm): 2.0 parts
Strontium titanate particles (number-average diameter=50 nm): 0.2 parts

These materials are mixed together in a Henschel mixer, giving toner 1.

### Examples 2 to 14, Example 19, and Comparative Examples 1 to 5

The toners of the Examples and Comparative Examples are obtained through the same process as in Example 1, except that the resins, their amounts, etc., are changed according to the formula in Tables 1 to 3.

### Example 15

Toner 15 is obtained through the same process as in Example 1, except that the temperature and screw rotational speed for kneading in Example 1 are changed to 100° C. and 600 rpm, respectively.

### Example 16

Toner 16 is obtained through the same process as in Example 1, except that the temperature and screw rotational speed for kneading in Example 1 are changed to 100° C. and 560 rpm, respectively.

### Example 17

Toner 17 is obtained through the same process as in Example 1, except that the temperature and screw rotational speed for kneading in Example 1 are changed to 130° C. and 200 rpm, respectively.

### Example 18

Toner 18 is obtained through the same process as in Example 1, except that the temperature and screw rotational speed for kneading in Example 1 are changed to 130° C. and 180 rpm, respectively.

The resulting toners of the Examples and Comparative Examples are characterized for the following parameters by the methods described above. The results are presented in Table 3. In Table 3, “-” indicates that material is not used.
Weight-average molecular weight of amorphous resin a1, Mw (a1)
Weight-average molecular weight of amorphous resin a2, Mw (a2)
Weight-average molecular weight of crystalline resin c1, Mw (c1)
Mw (a2)−Mw (a1)
Solubility parameter (SP) of amorphous resin a1, SP (a1)
Solubility parameter (SP) of amorphous resin a2, SP (a2)
Solubility parameter (SP) of crystalline resin c1, SP (c1)
   |SP (a1)−SP (c1)|/|SP (a2)−SP (c1)|
   |SP (a2)−SP (c1)|
Crystalline resin c1 content as a percentage to the toner particles
Crystalline resin c1 content as a percentage to the amorphous resins
Coefficient of variation of the areas of Voronoi cells
Average diameter of islands
Amorphous resin content as a percentage to the toner particles
Type of the amorphous resins
Type of the crystalline resin

In Table 3, the meanings of the abbreviations are as follows.
PES: A polyester resin
Hybrid: A hybrid resin, having polyester resin and styrene-acrylic copolymer segments

### Testing for Band-Shaped Defects on Images

For each Example or Comparative Example, a developer made with the toner is loaded into the developing component of FUJIFILM Business Innovation Corp.'s Apeos C2570d multifunction device placed under 30° C. conditions. Using this image forming apparatus, a 0.4% coverage image is produced continuously on 2000 sheets of A4-sized paper. Then an A4 full-page halftone image and full-page text are printed, and the formed image and text are visually inspected for band-shaped defects and graded according to the criteria below. The results are presented in Table 3. Criteria for Grading

A: No band appears.

B: Faint bands are noticed when examined closely, but are acceptable.

C: Band-shaped figures are faintly seen on the halftone image but are acceptable; they would cause no problem in practical use.

D: Bands are obvious on both the halftone image and text.

TABLE 1

| | | Polyester | | | | | | | | | Styrene-acrylic | | | |
|---|---|---|---|---|---|---|---|---|---|---|---|---|---|---|
| | | Acid monomers | | | | Alcohol monomers | | | | | | n-butyl | | |
| | | TPA | IPA | AA | TMA | BPA-2PO | BPA-3PO | BPA-2EO | NPG | PG | Styrene | acrylate | SP | Mw |
| Amorphous | a1-1 | 90 | 10 | | | 95 | | | 5 | | | | 10.20 | 18,000 |
| resin a1 | a1-2 | 95 | | | | 50 | 50 | | | | | | 10.06 | 16,000 |
| | a1-3 | 90 | 9.5 | | 0.5 | 95 | | | 5 | | | | 10.20 | 23,000 |
| | a1-4 | 90 | 10 | | | 95 | | | 5 | | | | 10.20 | 9,000 |
| | a1-5 | 80 | | | | 80 | | | | | 28 | 12 | 10.17 | 20,000 |
| | a1-6 | 95 | | 5 | | 70 | 30 | | | | | | 10.10 | 16,000 |
| | a1-7 | 90 | 10 | | | 95 | | | 5 | | | | 10.20 | 24,000 |
| | a1-8 | 90 | 10 | | | 95 | | | 5 | | | | 10.20 | 9,000 |
| Amorphous | a2-1 | 86 | 10 | | 4 | 15 | | 10 | | 75 | | | 10.98 | 65,000 |
| resin a2 | a2-2 | 86 | 10 | | 4 | 35 | | | 65 | | | | 10.34 | 71,000 |
| | a2-3 | 86 | 10 | | 4 | 15 | | 10 | | 75 | | | 10.98 | 35,000 |
| | a2-4 | 82 | 10 | | 8 | 15 | | 10 | | 75 | | | 11.02 | 151,000 |
| | a2-5 | 86 | 10 | | 4 | 50 | | | | 50 | | | 10.58 | 77,000 |
| | a2-6 | 86 | 10 | | 4 | 45 | | | | 55 | | | 10.64 | 60,000 |
| | a2-7 | 86 | 10 | | 4 | | | | 15 | 85 | | | 11.35 | 82,000 |
| | a2-8 | 86 | 10 | | 4 | | | | 10 | 90 | | | 11.42 | 90,000 |
| | a2-9 | 76 | | | 4 | | | | 15 | 65 | 28 | 12 | 10.95 | 88,000 |
| | a2-10 | 86 | 10 | | 4 | 85 | | | 15 | | | | 10.23 | 65,000 |
| | a2-11 | 86 | 10 | | 4 | 15 | | 10 | | 75 | | | 10.98 | 33,000 |
| | a2-12 | 82 | 10 | | 8 | 15 | | 10 | | 75 | | | 11.02 | 165,000 |

TABLE 2

| | | Polycarboxylic | Polyhydric | | |
|---|---|---|---|---|---|
| | | acid | alcohol | SP | Mw |
| Crystalline | c1-1 | Sebacic acid | 1,6-Hexanediol | 9.19 | 21,000 |
| resin c1 | c1-2 | Fumaric acid | 1,6-Hexanediol | 9.82 | 25,000 |
| | c1-3 | 1,12-Dodecane- | 1,9-Nonanediol | 8.89 | 18,000 |
| | | dicarboxylic acid | | | |
| | c1-4 | Terephthalic acid | 1,9-Nonanediol | 9.95 | 32,000 |

TABLE 3

| | Amorphous resins | | | | | | | | | | |
|---|---|---|---|---|---|---|---|---|---|---|---|
| | | | | | | | Amorphous | Crystalline resin | | | |
| | | | | | | | resin | | | | c1 |
| | a1 | a1 | Mw | a2 | a2 | Mw | content | | | SP | content |
| | structure | type | (a1) | structure | type | (a2) | (parts) | Structure | Type | (c1) | (parts) |
| Example 1 | PES | a1-1 | 18,000 | PES | a2-1 | 65,000 | 81 | PES | c1-1 | 9.19 | 8.6 |
| Example 2 | PES | a1-2 | 16,000 | PES | a2-1 | 65,000 | 81 | PES | c1-2 | 9.82 | 8.6 |
| Example 3 | PES | a1-1 | 18,000 | PES | a2-2 | 71,000 | 81 | PES | c1-1 | 9.19 | 8.6 |
| Example 4 | PES | a1-3 | 23,000 | PES | a2-3 | 35,000 | 81 | PES | c1-1 | 9.19 | 8.6 |
| Example 5 | PES | a1-4 | 9,000 | PES | a2-4 | 151,000 | 81 | PES | c1-1 | 9.19 | 8.6 |
| Example 6 | PES | a1-1 | 18,000 | PES | a2-5 | 77,000 | 81 | PES | c1-2 | 9.82 | 8.6 |
| Example 7 | PES | a1-1 | 18,000 | PES | a2-6 | 60,000 | 81 | PES | c1-2 | 9.82 | 8.6 |
| Example 8 | PES | a1-1 | 18,000 | PES | a2-7 | 82,000 | 81 | PES | c1-3 | 8.89 | 8.6 |
| Example 9 | PES | a1-1 | 18,000 | PES | a2-8 | 90,000 | 81 | PES | c1-3 | 8.89 | 8.6 |
| Example 10 | Hybrid | a1-5 | 20,000 | Hybrid | a2-9 | 88,000 | 81 | Hybrid | c1-1 | 9.19 | 8.6 |
| Example 11 | PES | a1-1 | 18,000 | PES | a2-1 | 65,000 | 86.4 | PES | c1-1 | 9.19 | 1.9 |
| Example 12 | PES | a1-1 | 18,000 | PES | a2-1 | 65,000 | 85.8 | PES | c1-1 | 9.19 | 2.6 |
| Example 13 | PES | a1-1 | 18,000 | PES | a2-1 | 65,000 | 64 | PES | c1-1 | 9.19 | 37.5 |
| Example 14 | PES | a1-1 | 18,000 | PES | a2-1 | 65,000 | 62 | PES | c1-1 | 9.19 | 41.9 |
| Example 15 | PES | a1-1 | 18,000 | PES | a2-1 | 65,000 | 86.4 | PES | c1-1 | 9.19 | 8.6 |
| Example 16 | PES | a1-1 | 18,000 | PES | a2-1 | 65,000 | 86.4 | PES | c1-1 | 9.19 | 8.6 |
| Example 17 | PES | a1-1 | 18,000 | PES | a2-1 | 65,000 | 86.4 | PES | c1-1 | 9.19 | 8.6 |
| Example 18 | PES | a1-1 | 18,000 | PES | a2-1 | 65,000 | 86.4 | PES | c1-1 | 9.19 | 8.6 |
| Example 19 | PES | a1-6 | 16,000 | PES | a2-1 | 65,000 | 81 | PES | c1-4 | 9.95 | 8.6 |
| Comparative | PES | a1-1 | 18,000 | PES | a2-10 | 62,000 | 81 | PES | c1-1 | 9.19 | 8.6 |
| Example 1 | | | | | | | | | | | |
| Comparative | PES | a1-7 | 24,000 | PES | a2-11 | 33,000 | 81 | PES | c1-1 | 9.19 | 8.6 |
| Example 2 | | | | | | | | | | | |
| Comparative | PES | a1-8 | 9,000 | PES | a2-12 | 165,000 | 81 | PES | c1-1 | 9.19 | 8.6 |
| Example 3 | | | | | | | | | | | |
| Comparative | PES | a1-1 | 18,000 | — | — | — | 81 | PES | c1-1 | 9.19 | 8.6 |
| Example 4 | | | | | | | | | | | |
| Comparative | — | — | — | PES | a2-1 | 65,000 | 81 | PES | c1-1 | 9.19 | 8.6 |
| Example 5 | | | | | | | | | | | |

| | Average | | | | Coefficient of | |
|---|---|---|---|---|---|---|
| | diameter | | Formula (2) | | variation of | |
| | of islands | Formula (1) | \|SP (a1) − SP (c1)\|/ | Formula (3) | the areas of | |
| | (nm) | Mw (a2) − Mw (a1) | \|SP (a2) − SP (c1)\| | SP (a2) − SP (c1) | Voronoi cells | Testing |
| Example 1 | 400 | 47,000 | 0.56 | 1.79 | 0.65 | A |
| Example 2 | 320 | 49,000 | 0.21 | 1.16 | 1.40 | B |
| Example 3 | 370 | 53,000 | 0.88 | 1.15 | 0.35 | B |
| Example 4 | 450 | 12,000 | 0.56 | 1.79 | 0.34 | B |
| Example 5 | 300 | 142,000 | 0.55 | 1.83 | 0.37 | B |
| Example 6 | 200 | 59,000 | 0.50 | 0.76 | 0.32 | C |
| Example 7 | 240 | 42,000 | 0.46 | 0.82 | 0.36 | B |
| Example 8 | 360 | 64,000 | 0.53 | 2.46 | 1.35 | B |
| Example 9 | 500 | 72,000 | 0.52 | 2.53 | 1.55 | C |
| Example 10 | 380 | 68,000 | 0.59 | 1.67 | 0.60 | A |
| Example 11 | 400 | 47,000 | 0.56 | 1.79 | 0.33 | C |
| Example 12 | 400 | 47,000 | 0.56 | 1.79 | 0.41 | B |
| Example 13 | 400 | 47,000 | 0.56 | 1.79 | 1.42 | B |
| Example 14 | 400 | 47,000 | 0.56 | 1.79 | 1.54 | C |
| Example 15 | 90 | 47,000 | 0.56 | 1.79 | 0.31 | C |
| Example 16 | 120 | 47,000 | 0.56 | 1.79 | 0.39 | B |
| Example 17 | 780 | 47,000 | 0.56 | 1.79 | 1.48 | B |
| Example 18 | 830 | 47,000 | 0.56 | 1.79 | 1.55 | C |
| Example 19 | 480 | 49,000 | 0.15 | 1.03 | 1.55 | C |
| Comparative | 300 | 44,000 | 0.97 | 1.04 | 0.25 | D |
| Example 1 | | | | | | |
| Comparative | 250 | 9,000 | 0.56 | 1.79 | 0.25 | D |
| Example 2 | | | | | | |
| Comparative | 550 | 156,000 | 0.55 | 1.83 | 0.28 | D |
| Example 3 | | | | | | |
| Comparative | 300 | — | — | — | 0.21 | D |
| Example 4 | | | | | | |
| Comparative | 650 | — | — | 1.79 | 0.24 | D |
| Example 5 | | | | | | |

As can be seen from the results, the toners of the Examples, compared with those of the Comparative Examples, may help reduce band-shaped defects on images.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A toner for developing an electrostatic charge image, the toner comprising toner particles that contain binder resins, wherein:
the binder resins include amorphous resins and at least one crystalline resin, the amorphous resins including amorphous resin a1 and amorphous resin a2, the crystalline resin including crystalline resin c1; and
10,000≤Mw(a2)−Mw(a1)≤150,000 (1), and

|SP(a1)−SP(c1)|/|SP(a2)−SP(c1)|≤0.9 (2),
where Mw (a1) is a weight-average molecular weight of amorphous resin a1,
Mw (a2) is a weight-average molecular weight of amorphous resin a2,
SP (a1) is a solubility parameter, SP, of amorphous resin a1,
SP (a2) is a solubility parameter, SP, of amorphous resin a2, and
SP (c1) is a solubility parameter, SP, of crystalline resin c1.

2. The toner according to claim 1 for developing an electrostatic charge image, wherein:
0.2≤|SP(a1)−SP(c1)|/|SP(a2)−SP(c1)|≤0.9 (2-2).

3. The toner according to claim 1 for developing an electrostatic charge image, wherein:
0.8|SP(a2)−SP(c1)≤|2.5 (3).

4. The toner according to claim 1 for developing an electrostatic charge image, wherein a crystalline resin c1 content as a percentage to the toner particles is 2% by mass or more and 25% by mass or less.

5. The toner according to claim 4 for developing an electrostatic charge image, wherein a crystalline resin c1 content as a percentage to the amorphous resins is 2% by mass or more and 40% by mass or less.

6. A toner for developing an electrostatic charge image, the toner comprising toner particles that contain binder resins, wherein:
the toner particles have a sea-island structure in which a sea contains an amorphous resin, and islands contain a crystalline resin; and
when a Voronoi tessellation is generated from centroids of the islands in the sea-island structure, a coefficient of variation of areas of Voronoi cells is 0.3 or more.

7. The toner according to claim 6 for developing an electrostatic charge image, wherein the coefficient of variation of areas of Voronoi cells is 0.3 or more and 1.5 or less.

8. The toner according to claim 6 for developing an electrostatic charge image, wherein the islands have an average diameter of 100 nm or more and 800 nm or less.

9. The toner according to claim 1 for developing an electrostatic charge image, wherein an amorphous resin content as a percentage to the toner particles is 35% by mass or more and 95% by mass or less.

10. The toner according to claim 1 for developing an electrostatic charge image, wherein the amorphous resins include at least one of an amorphous polyester resin or a hybrid resin having a polyester resin segment and a styrene-acrylic copolymer segment.

11. The toner according to claim 1 for developing an electrostatic charge image, wherein the crystalline resin includes a crystalline polyester resin.

12. An electrostatic charge image developer comprising the toner according to claim 1 for developing an electrostatic charge image.

13. A toner cartridge attachable to and detachable from an image forming apparatus, the toner cartridge comprising the toner according to claim 1 for developing an electrostatic charge image.

14. A process cartridge attachable to and detachable from an image forming apparatus, the process cartridge comprising a developing component that contains the electrostatic charge image developer according to claim 12 and develops, using the electrostatic charge image developer, an electrostatic charge image on a surface of an image carrier to form a toner image.

15. An image forming apparatus comprising:
an image carrier;
a charging component that charges a surface of the image carrier;
an electrostatic charge image creating component that creates an electrostatic charge image on the charged surface of the image carrier;
a developing component that contains the electrostatic charge image developer according to claim 12 and develops, using the electrostatic charge image developer, the electrostatic charge image on the surface of the image carrier to form a toner image;
a transfer component that transfers the toner image on the surface of the image carrier to a surface of a recording medium; and
a fixing component that fixes the toner image on the surface of the recording medium.
